(19) United States
(12) Patent Application Publication
(10) Pub. No.: US 2014/0354588 A1
(43) Pub. Date: Dec. 4, 2014

(54) ACTIVE CAPACITIVE TOUCH DEVICE

(71) Applicant: Ching-Chung HSIAO, Tucheng City (TW)

(72) Inventors: Ching-Chung HSIAO, Tucheng City (TW); Fu-Chin SHEN, Tucheng City (TW)

(73) Assignee: Ching-Chung HSIAO, Tucheng City (TW)

(21) Appl. No.: 14/268,300

(22) Filed: May 2, 2014

(30) Foreign Application Priority Data
Jun. 3, 2013 (TW) 102119549

(51) Int. Cl. G06F 3/044

(52) U.S. Cl. CPC G06F 3/044
USPC 345/174

(57) ABSTRACT

The invention provides an active capacitive touch device applied to a capacitive touch panel to form a contact point for a user. The capacitive touch panel comprises a drive circuit which produces a signal with frequency. The active capacitive touch device comprises a contact element and a simulated inductance circuit. The contact element is used to contact the capacitive touch panel. The simulated inductance circuit is coupled to the contact element and enhances the ability of the active capacitive touch device receiving the signal with frequency to make the capacitive touch panel detect the position of the contact point.

### CROSS-REFERENCE TO RELATED APPLICATIONS

This Non-provisional application claims priority under 35 U.S.C. §119(a) on Patent Application No(s). 102119549 filed in Taiwan, Republic of China Jun. 3, 2013, the entire contents of which are hereby incorporated by reference.

### FIELD OF THE INVENTION

The invention is related to a capacitive touch device, more particularly to an active capacitive touch device.

### BACKGROUND OF THE INVENTION

With the development of touch technology and the launch of smart phones and tablet PCs, users can intuitively operate the touch devices through fingers. Capacitive touch is a common principle. The capacitive touch panel includes a driving circuit, and the driving circuit transmits a signal with frequency. The contact point between the touch object, such as a finger, and the capacitive touch panel forms capacitance value to absorb the signal with frequency, and further to make the capacitive touch panel detect the position of the contact point. It can provide human-computer interaction, but for the capacitive touch panel, there are still a number of problems:

First, the capacitive touch panel must be disposed at the front of the display module, ant it may directly affect the display performance. It is more serious particularly to reflective screens, such as electronic ink display screen and other types of display. Therefore, it is difficult for above types of displays to use the touch technology.

Second, the touch object, such as a finger, needs larger area of the contact point to conduct electricity, and further to make the capacitive touch panel detect the position of the contact point effectively.

The definition of the capacity is shown as following and FIG. 1:

C=εᵣε₀^{A}_{d}
C: Capacity
A: Overlap area of two conductive plates
εᵣ: Relative static permittivity of the material between the two conductive plates
ε₀: Vacuum permittivity
d: Distance between the two conductive plates

It is known that the larger the overlap area of two conductive plates is, the larger the capacity is. It is to say that when the contact area of a touch panel is too small, the capacity becomes too low to absorb signals efficiently, and further to make the touch insensitive.

Third, the accuracy and sensitivity of the touch may be affected by foreign matter on the touch surface, for example, perspiration on fingers will cause the sensitivity decrease.

Therefore, it was suggested that a passive stylus can be used as the touch object of the capacitive touch panel. The passive stylus includes conductivity, and it is similar to the property of the fingers. A conventional passive stylus usually includes a conductive rod with circular contact surface. The contact area of the circular surface must be large enough to sufficiently absorb the signals transmitted from the driving circuit of the capacitive touch panel. Please refer to FIG. 2, showing a diagram of the conventional passive stylus. When a user uses the circular contact surface 2 of the passive stylus to contact the capacitive touch panel 50, the user's body can be taken as a capacitor 60, the static electricity of the user's body will flow into the ground and produce a weak current which forms capacitive effect 10 between the circular contact surfaces 2 of the passive stylus and the surface of the capacitive touch panel 50. For the current with higher frequency, the capacitor is a good conductor with low impedance, so the circular contact surfaces 2 of the passive stylus attracts a small current from the contact point between with the capacitive touch panel 50, so as to generate a signal to the capacitive touch panel 50. As previously mentioned, the contact area between the circular contact surface 2 of the passive stylus and the capacitive touch panel 50 must be large enough to generate effective touch, thus the capacitive touch panel can sense the contact point.

In addition, the frequency of signals emitted from the driver circuit of the capacitive touch panel produced by each manufacturer is not the same. If the user hopes to use a stylus to support various capacitive touch panels produced by different manufacturers, he must use a passive stylus, but the passive stylus includes the foregoing problem of needing a larger contact area. Later, an active stylus is developed for specific products (corresponding to the signal frequency of the manufacturer's own panels). The active stylus includes a driver circuit and an electrode, and the output electric field corresponds to the sensing circuit of their own panel products to increase the accuracy of the touch panel. The active stylus is also equipped with a sensing circuit and electrodes to sense the feedback signals of the touch panel for touch identification. However, the structure of the active stylus is very complex, and it causes high production costs. Besides, the active stylus still cannot be used to other manufacturers' capacitive touch panel.

Moreover, someone applied a resonant principle in the touch panel to enhance the sensing ability of the touch panel. However, only the touch panels applied resonant principle can include better sensing ability, and it means that not all of the touch panels include better sensing ability.

Therefore, the above two conventional technologies cannot provide the user to use a stylus to operate any capacitive touch panel with an arbitrary and high sensitivity.

As a result, the present invention provides an active capacitive touch device to resolve the defects of conventional techniques.

### SUMMARY OF THE INVENTION

The present invention uses the series resonant principle in the active capacitive touch device to allow the signals completely pass and be absorbed at a specific frequency range. The active capacitive touch device provided by the present invention is applied to a capacitive touch panel to form a contact point for a user. The contact point between the active capacitive touch device and the capacitive touch panel forms capacitance effect. Moreover, the capacitive touch panel comprises a drive circuit which produces a signal with frequency. The active capacitive touch device comprises a contact element and a simulated inductance circuit.

The contact element of the present invention is used to contact the capacitive touch panel for the user. The simulated inductance circuit of the present invention is coupled to the contact element. The simulated inductance circuit can enhance the ability of the active capacitive touch device receiving the signal with frequency to make the capacitive touch panel detect the position of the contact point.

In an embodiment, the simulated inductance circuit is an inductance element. The active capacitive touch device of the present invention contacts the capacitive touch panel via the contact elements, and absorbs the signal with frequency produced by the drive circuit of the capacitive touch panel via the capacitive effect formed by the contact point between the both. The active capacitive touch- device of the present invention also uses inductive element to enhance the response of specific frequency, which is not limited herein.

In an embodiment, the simulated inductance circuit is an operational amplifier, and the operational amplifier includes a feedback capacitor. The operational amplifier can be connected to a resistor element in parallel. The active capacitive touch device of the present invention contacts the capacitive touch panel via the contact elements, and absorbs the signal with frequency produced by the drive circuit of the capacitive touch panel via the capacitive effect formed by the contact point between the both. The active capacitive touch device of the present invention also uses the operational amplifier combining a feedback capacitor to increase the response of specific frequency, which is not limited herein.

In an embodiment, the simulated inductance circuit is coupled to an impedance transformation circuit. The impedance transformation circuit comprises an operational amplifier and a resistance element. The resistance element is connected to the operational amplifier in parallel. The active capacitive touch device of the present invention contacts the capacitive touch panel via the contact elements, and absorbs the signal with frequency produced by the drive circuit of the capacitive touch panel via the capacitive effect formed by the contact point between the both. The active capacitive touch device of the present invention also uses the operational amplifier of the simulated inductance circuit combining a feedback capacitor, and the operational amplifier of the impedance transformation circuit combining a feedback capacitor and connecting to the resistance element in parallel to enhance the response of specific frequency and frequency bandwidth, which is not limited herein.

The active capacitive touch device of the present invention uses the series resonant principle to improve the ability for absorbing the signals with frequency and increase the sensitivity of the capacitive touch panel. The present invention uses the operational amplifier to transfer impedance, and also uses the resistance element or the capacitor element to be transfered into an inductance, and further to enhance the response of specific frequency. The present invention even uses an adjustable capacitor element or an adjustable inductance element to automatically or manually adjust the specific frequency received. Therefore, the active capacitive touch device of the present invention can be applied to all kinds of capacitive touch panels. The structure of the active capacitive touch device is relatively simpler than prior art, and further can decrease the production cost. Because the ability for absorbing the signals with frequency of the active capacitive touch device is improved, the contact area of the capacitive touch panel can be reduced to operate the capacitive touch panel more accurately.

### BRIEF DESCRIPTION OF THE DRAWINGS

FIG. 1 shows a schematic diagram of the definition of the capacity.

FIG. 2 is a schematic diagram of the conventional passive stylus.

FIG. 3 is a schematic diagram of series resonant circuit.

FIG. 4A is a schematic diagram of a single capacitor element.

FIG. 4B is a schematic diagram of a capacitor element connected to an inductive element in series.

FIG. 4C is a curve diagram of conduction data in FIG. 4A and FIG. 4B.

FIG. 5 is a schematic diagram of a first embodiment of the active capacitive touch device in the present invention.

FIG. 6 is a schematic diagram of a second embodiment of the active capacitive touch device in the present invention.

FIG. 7 is a schematic diagram of the second embodiment of the operational amplifier.

FIG. 8 is a schematic diagram of a third embodiment of the active capacitive touch device in the present invention.

FIG. 9 is a comparison diagram of the frequency response formed by the active capacitive touch device of the prior art and the present invention.

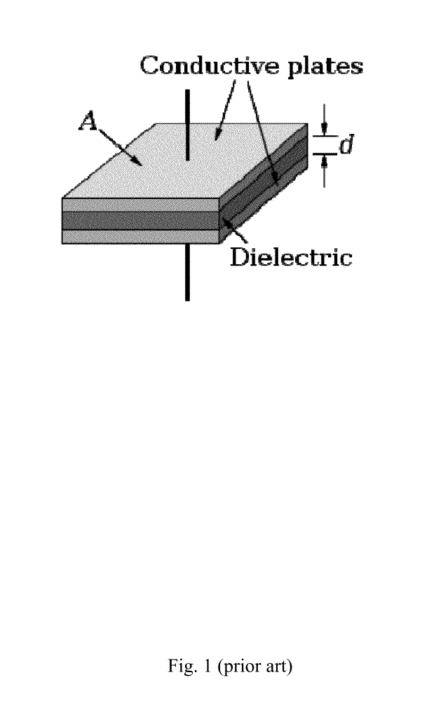

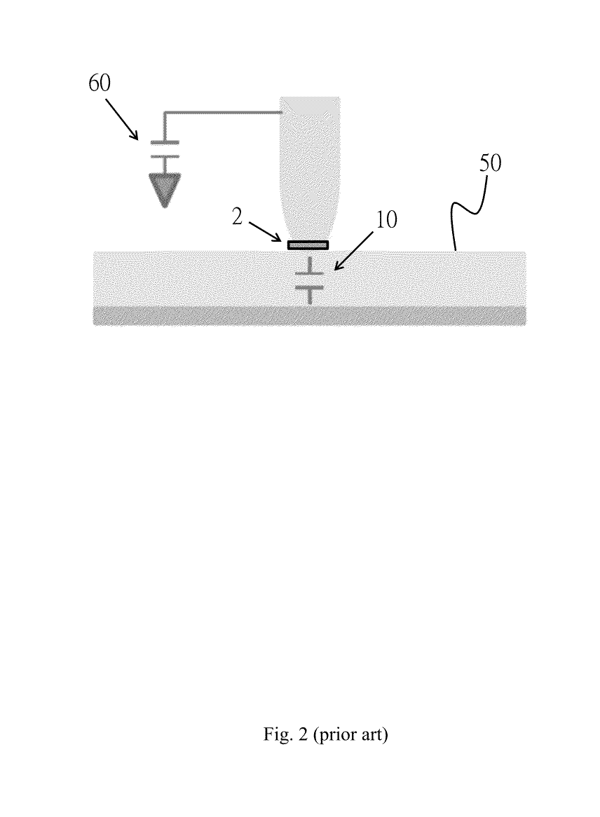

### DETAILED DESCRIPTION OF THE INVENTION

For clarity of disclosure, and not by way of limitation, the detailed description of the invention is divided into the subsections that follow.

It is known that the less the contact area of a touch panel and an operating element is, the more accurate the operating element controlling the touch panel is. However, reducing the touch area may lead to decrease capacitance, the ability absorbing frequency signals of the touch panel may also decrease. In view of this, the active capacitive touch device provided by the present invention uses series resonant principle, which the definition of the capacitor impedance is as the following equations. It is known that the higher the capacitance is, the lower the both ends of the impedance are, and the signals are more easily absorbed. The series resonant principle used by the present invention can allow the signals of the active capacitive touch device completely pass and be absorbed at a specific frequency range.

$$X = - \frac{1}{ω C} = - \frac{1}{2 π f C}$$

$$Z = \frac{1}{jω C} = - \frac{j}{ω C} = - \frac{j}{2 π f C}$$

The main reason is that an inductive element connected to a signal absorbing path in series generates a series resonant point. The signal won't be destroyed and will be completely absorbed at the resonant frequency

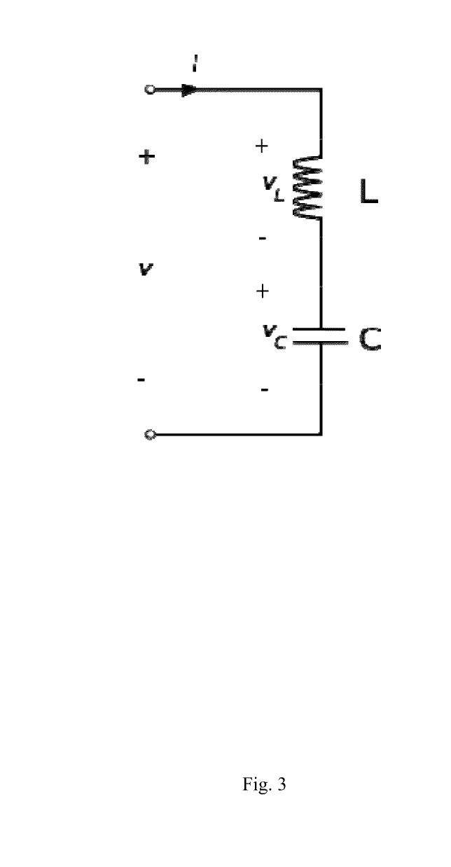

Please refer to FIG. 3, showing a schematic diagram of series resonant circuit. ω=ω₀ can be derived from the equations of X_{L} and ω_{L}. The definition of the ω is the resonance angular frequency of the circuit, and the frequency f₀ generated by the driving circuit of the touch panel is derived from the resonance angular frequency.

$${X}_{L} = - {X}_{C}$$

$$ω L = \frac{1}{ω C}$$

$$ω = {ω}_{0} = \frac{1}{\sqrt{LC}}$$

$${f}_{0} = \frac{{ω}_{0}}{2 π} = \frac{1}{2 π √ LC}$$

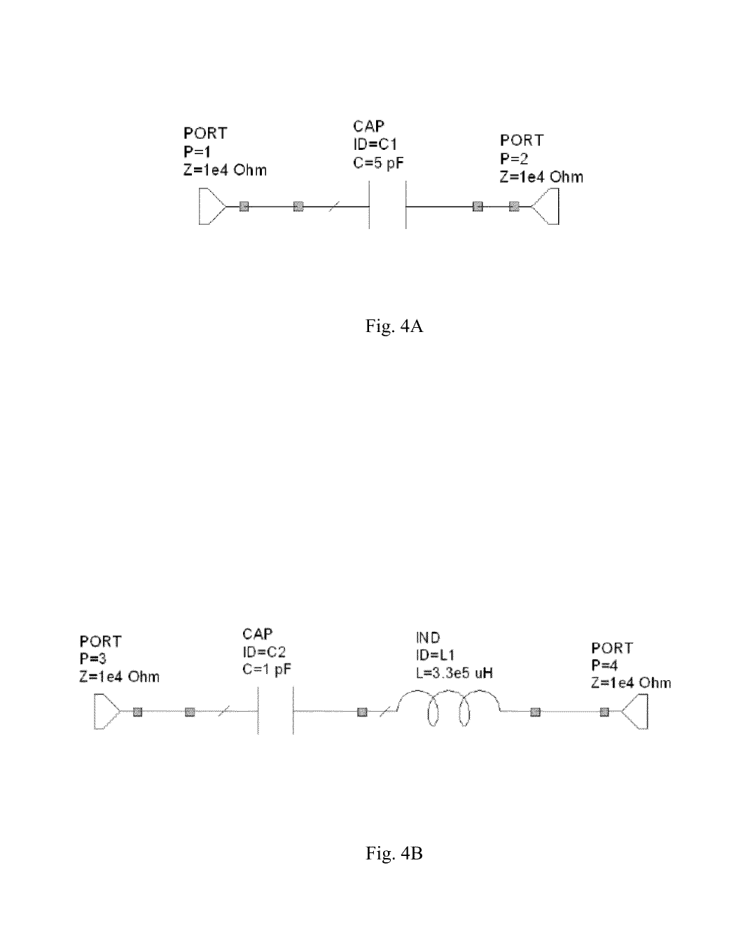

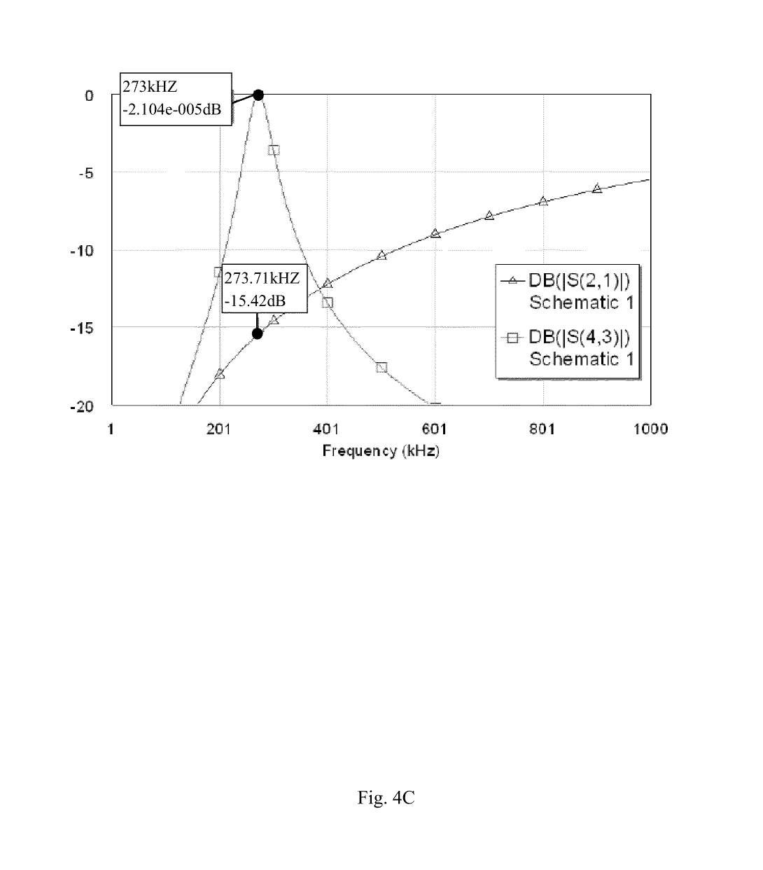

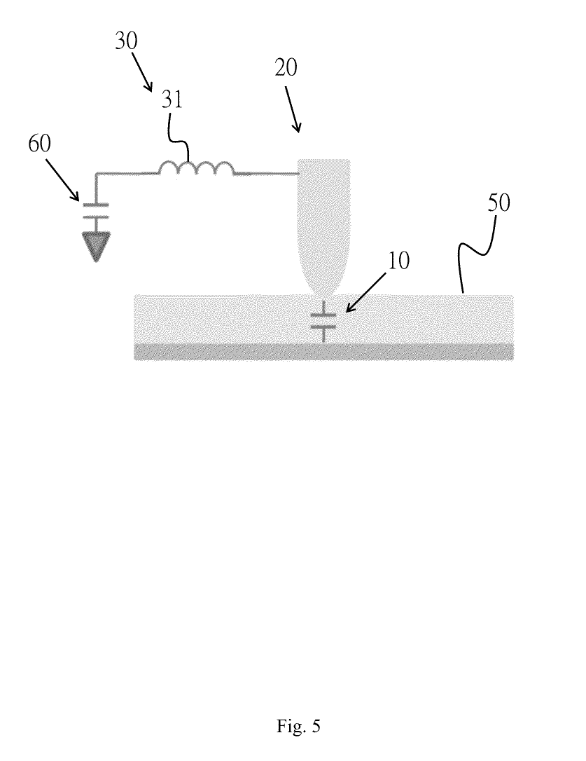

Please refer to FIG. 4A, FIG. 4B, and FIG. 4C, the FIG. 4A shows a schematic diagram of a single capacitor element, the FIG. 4B shows a schematic diagram of a capacitor element connected to an inductive element in series, and the FIG. 4C shows a curve diagram of conduction data in FIG. 4A and FIG. 4B. It is known from the FIG. 4C that in the same situation of 273 kHz, the conductive ability of a capacitor element connected to an inductive element in series (square marks in FIG. 4C) is better than the conductive ability of a single capacitor element (triangle marks in FIG. 4C) in a specific frequency.

The active capacitive touch device provided by the present invention is applied to a capacitive touch panel to form a contact point for a user. The contact point between the active capacitive touch and the capacitive touch panel forms capacitance effect. Moreover, the capacitive touch panel comprises a drive circuit which produces a signal with frequency. The active capacitive touch device comprises a contact element and a simulated inductance circuit.

The contact element of the present invention is used to contact the capacitive touch panel for the user. The material of the contact element is conductive material or dielectric material. Besides, in the situation not affecting capacitance effect, the contact element can be coated with non-conducting material, which is not limited herein.

The simulated inductance circuit of the present invention is coupled to the contact element. The simulated inductance circuit can enhance the ability of the active capacitive touch device receiving the signal with frequency to make the capacitive touch panel detect the position of the contact point. The simulated inductance circuit can be coupled to a power, which is not limited herein.

Please refer to FIG. 5 showing a schematic diagram of a first embodiment of the active capacitive touch device in the present invention. In the embodiment, the simulated inductance circuit 30 is an inductance element 31. The active capacitive touch device of the present invention contacts the capacitive touch panel 50 via the contact elements 20, and absorbs the signal with frequency produced by the drive circuit (not shown) of the capacitive touch panel 50 via the capacitive effect 10 formed by the contact point between the both. The active capacitive touch device of the present invention also uses inductive element 31 to increase the response of specific frequency, and further to enhance the ability of the active capacitive touch device receiving the signal with frequency, which is not limited herein.

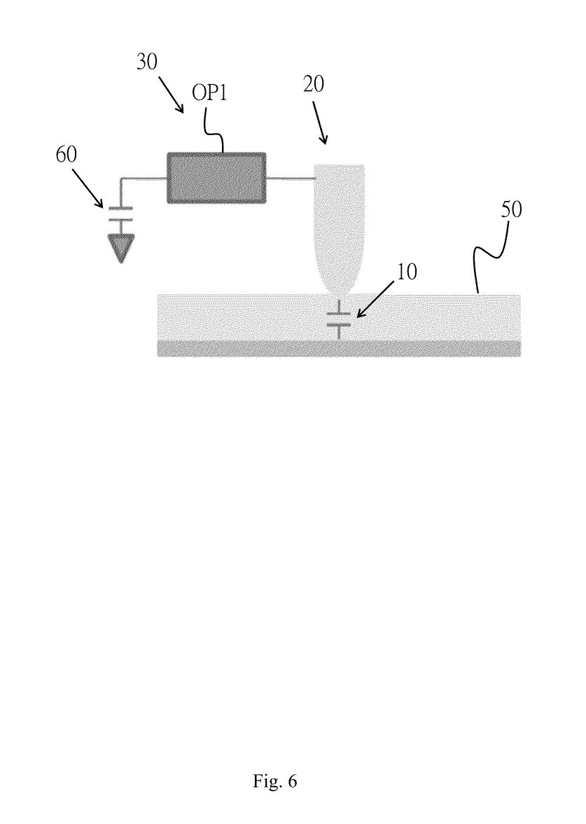

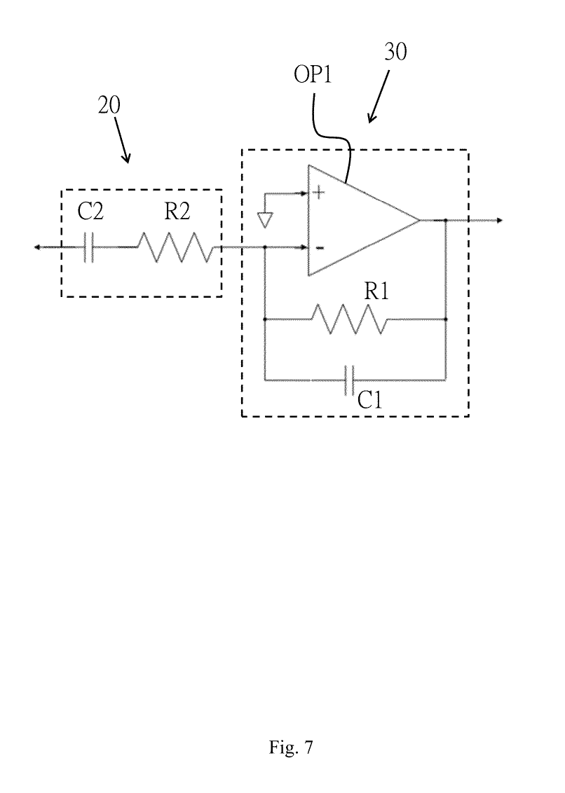

In the first embodiment, the quality factor (Q) of connecting to a single inductance element in series is high, but the frequency range may be lower. The present invention can be implemented by using an active amplifier to perform preferred inductance effect. Please refer to FIG. 6 and FIG. 7. FIG. 6 shows a schematic diagram of a second embodiment of the active capacitive touch device in the present invention. FIG. 7 shows a schematic diagram of the second embodiment of the operational amplifier. In the embodiment, the simulated inductance circuit 30 is an operational amplifier OP1, and the operational amplifier OP1 includes a feedback capacitor C1. The operational amplifier OP1 can be connected to a resistor element R1 in parallel. In the situation, the contact element 20 can be considered as a series circuit of a capacitor element C2 and a resistor element R2. The series circuit is connected to the simulated inductance circuit 30 in series. The active capacitive touch device of the present invention contacts the capacitive touch panel 50 via the contact elements 20, and absorbs the signal with frequency produced by the drive circuit (not shown) of the capacitive touch panel 50 via the capacitive effect 10 formed by the contact point between the both. The active capacitive touch device of the present invention also uses the operational amplifier OP1 combining a feedback capacitor C1 to increase the response of specific frequency, and further to enhance the ability of the active capacitive touch device receiving the signal with frequency, which is not limited herein.

In a second embodiment, please refer to the following equations, in the series circuit, X_{C} and X_{L} should counteract each other in theory. However, in fact, the current of an idealized element is reversed, so the main reason for this is because of the influence of the resistances generated by the coil. As a result, the current provides the series resonant circuit a maximum resonance. When f approaches to f₀, the current is maximum, and the impedance of the circuit is minimum. In the situation, the circuit is called an acceptor circuit. When f<f₀ and X_{L}<<(−X_{C}), the current is called a capacitor circuit. When f>f₀ and X_{L}>>(−X_{C}), the current is called a inductance circuit.

$${Z}_{in} = - R // \frac{1}{jω C}$$

$${Z}_{in} = - \frac{R ( \frac{1}{jω C} )}{R + ( \frac{1}{j ω C} )} = - \frac{\frac{R}{j ω C}}{\frac{j ω RC + 1}{j ω C}}$$

$${Z}_{in} = - \frac{R}{j ω RC + 1} = - \frac{R ( - jω RC + 1 )}{( j ω R C + 1 ) ( - j ω RC + 1 )}$$

$${Z}_{in} = - \frac{( - jω {R}^{2} C + R )}{( 1 + {( RC )}^{2} )} = \frac{( jω {R}^{2} C - R )}{( 1 + {( RC )}^{2} )}$$

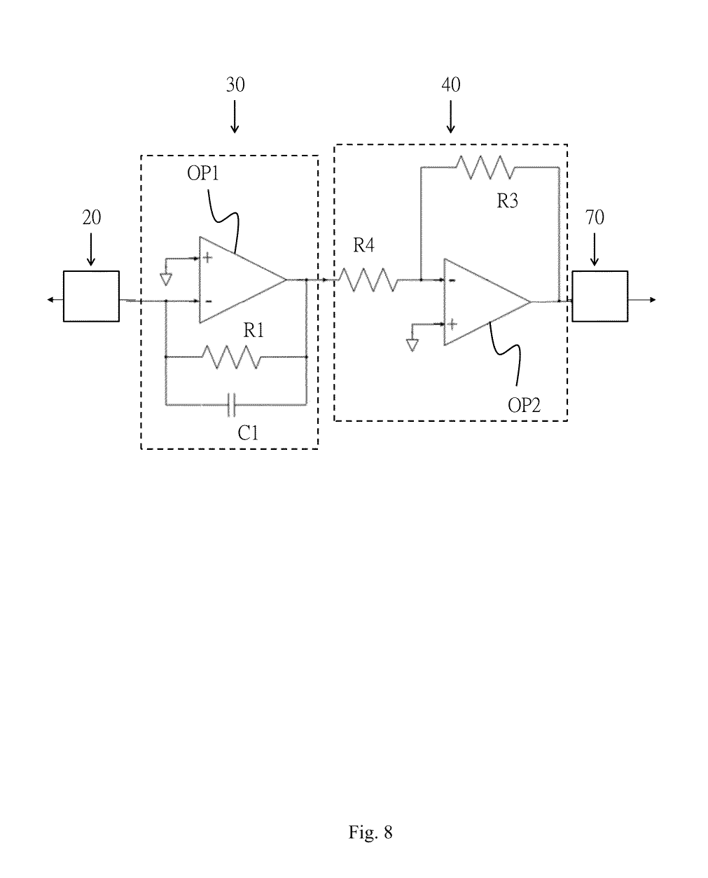

Please refer to FIG. 8, showing a schematic diagram of a third embodiment of the active capacitive touch device in the present invention. In the embodiment, the simulated inductance circuit 30 is coupled to an impedance transformation circuit 40. One end of the impedance transformation circuit 40 is coupled to a power 70, and the other end of the impedance transformation circuit 40 is coupled to the simulated inductance circuit 30. The impedance transformation circuit 40 comprises an operational amplifier OP2, a resistance element R3 and a resistance element R4. The resistance element R3 is connected to the operational amplifier OP2 in parallel, and the resistance element R4 is connected to the parallel circuit of the resistance element R3 and the operational amplifier OP2 in series. The active capacitive touch device of the present invention contacts the capacitive touch panel 50 via the contact elements 20, and absorbs the signal with frequency produced by the drive circuit (not shown) of the capacitive touch panel 50 via the capacitive effect 10 formed by the contact point between the both. The active capacitive touch device of the present invention also uses the operational amplifier OP1 of the simulated inductance circuit 30 combining a feedback capacitor C1, and the operational amplifier OP2 of the impedance transformation circuit 40 combining a feedback capacitor and connecting to the resistance element R3 in parallel to increase the response of specific frequency and frequency bandwidth, and further to enhance the ability of the active capacitive touch device receiving the signal with frequency, which is not limited herein.

Besides, the resistance element or the capacitor element of the invention can be an adjustable resistance element or an adjustable capacitor element, which is not limited herein.

In an embodiment, a signal absorption circuit can be integrated in an integrated circuit (IC), which is not limited herein.

In an embodiment, the active capacitive touch device of the invention can be a stylus or touch gloves, which is not limited herein.

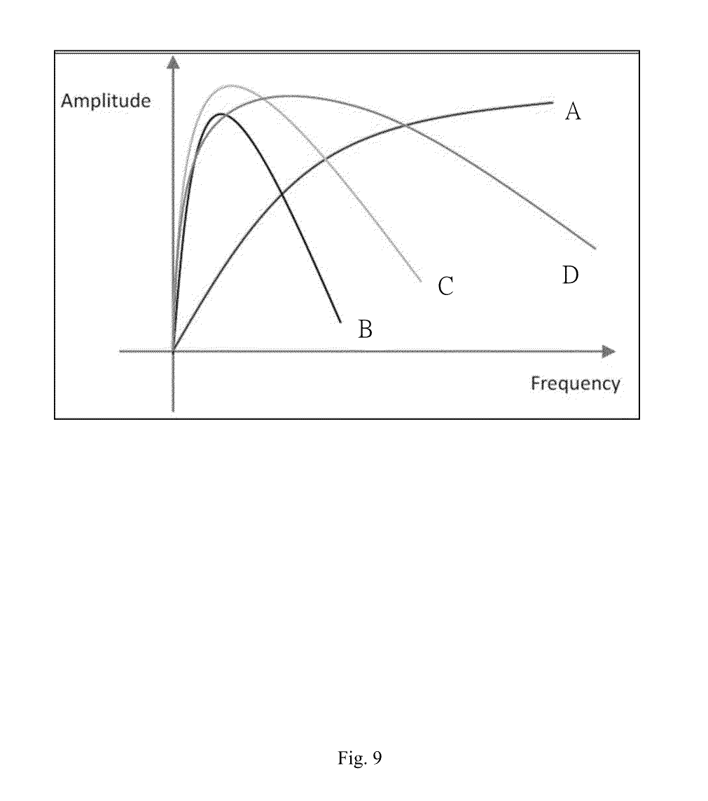

Please refer to FIG. 9, showing a comparison diagram of the frequency response formed by the active capacitive touch device of the prior art and the invention. The curve A in FIG. 9 represents the capacity of human body contacting in the prior art. The curve B in FIG. 9 represents the enhanced frequency response formed by using inductive element in the first embodiment of the invention. The curve C in FIG. 9 represents the enhanced frequency response formed by using the operational amplifier combining a feedback capacitor in the second embodiment of the invention. The curve D in FIG. 9 represents the enhanced frequency response and frequency bandwidth formed by using the operational amplifier combining a feedback capacitor and connecting to the resistance element in parallel in the third embodiment of the invention. It is known from above that the series resonant principle used by the active capacitive touch device of the present invention can improve the ability to absorb the signals with frequency.

The active capacitive touch device of the present invention uses the series resonant principle to improve the ability for absorbing the signals with frequency and increase the sensitivity of the capacitive touch panel. The present invention uses the operational amplifier to transfer impedance, and also uses the resistance element or the capacitor element to be transfered into an inductance, and further to enhance the response of specific frequency. The present invention even uses an adjustable capacitor element or an adjustable inductance element to automatically or manually adjust the specific frequency received. Therefore, the active capacitive touch device of the present invention can be applied to all kinds of capacitive touch panels. The structure of the active capacitive touch device is relatively simpler than prior art, and further can decrease the production cost. Because the ability for absorbing the signals with frequency of the active capacitive touch device is improved, the contact area of the capacitive touch panel can be reduced to operate the capacitive touch panel more accurately.

Although the, present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. An active capacitive touch device, applied to a capacitive touch panel to form a contact point, the capacitive touch panel comprises a drive circuit which produces a signal with frequency, and the active capacitive touch device comprising:
a contact element, used to contact the capacitive touch panel; and
a simulated inductance circuit, coupled to the contact element, and enhancing the ability of the active capacitive touch device receiving the signal with frequency to make the capacitive touch panel detect the position of the contact point.

2. The active capacitive touch device according to claim 1, wherein the simulated inductance circuit is an inductance element.

3. The active capacitive touch device according to claim 1, wherein the simulated inductance circuit is an operational amplifier.

4. The active capacitive touch device according to claim 3, wherein the operational amplifier comprises a feedback capacitor.

5. The active capacitive touch device according to claim 4, wherein the operational amplifier connects to a resistance element in parallel.

6. The active capacitive touch device according to claim 1, wherein the material of the contact element is conductive material or dielectric material.

7. The active capacitive touch device according to claim 1, wherein the simulated inductance circuit is coupled to a power.

8. The active capacitive touch device according to claim 1, further comprises an impedance transformation circuit.

9. The active capacitive touch device according to claim 8, wherein one end of the impedance transformation circuit is coupled to a power, and the other end of the impedance transformation circuit is coupled to the simulated inductance circuit.

10. The active capacitive touch device according to claim 8, wherein the impedance transformation circuit comprises an operational amplifier and a resistance element.

11. The active capacitive touch device according to claim 2, wherein the inductance element is an adjustable inductance element.

12. The active capacitive touch device according to claim 1 is a stylus or touch gloves.

13. The active capacitive touch device according to claim 1, wherein the contact element is coated with non-conducting material.
